(19) United States
(12) Patent Application Publication
(10) Pub. No.: US 2014/0368669 A1
(43) Pub. Date: Dec. 18, 2014

(54) GPU-ACCELERATED BACKGROUND REPLACEMENT

(71) Applicants: Eino-Ville Aleksi Talvala, Menlo Park, CA (US); Shiqi Chen, Emeryville, CA (US)

(72) Inventors: Eino-Ville Aleksi Talvala, Menlo Park, CA (US); Shiqi Chen, Emeryville, CA (US)

(73) Assignee: Google Inc.

(21) Appl. No.: 13/645,063

(22) Filed: Oct. 4, 2012

(51) Int. Cl. H04N 5/272

(52) U.S. Cl. 348/207.1; 348/E05.058

(57) ABSTRACT

Methods, systems, and apparatus, including computer programs encoded on a computer storage medium, for real-time background replacement. Visual characteristics of a visual background, comprised of an image or series of images that make up a motion video, are identified. Frames of a real-time video are captured with a video camera. Foreground areas are distinguished from background areas in the frames of the real-time video by using the visual background. The visual background displays an area that overlaps with an area in the one or more captured frames. The modifying occurs in real-time with capturing the frames by the video camera. Video data is provided for display that superimposes images from the foreground areas over the visual background without superimposing the background areas. The identified visual characteristics of the visual background are used to modify visual characteristics of particular pixels in the obtained one or more frames of the real-time video.

### TECHNICAL FIELD

This document relates to components of computer applications, including components for graphical rendering.

### BACKGROUND

Computer operating systems perform a number of functions, including serving as a bridge between computer hardware and computer applications that run on the operating systems. Modern computer operating systems also provide basic graphical user interfaces (GUIs) by which users can interact with components of the operating system in more intuitive manners.

In some computing systems, the resources available for rendering graphics may include hardware acceleration, which, when utilized, may increase system performance and allow for superior graphics rendering by providing dedicated hardware, such as a graphics processing unit (GPU), to more quickly process code that requires significant computational resources. A system may therefore provide access to hardware acceleration for many applications.

Computing systems may further include video imaging capabilities, allowing a user to create a video for real-time (streaming) transmission as well as recording the video for later use. In creating and particularly in streaming videos, real-time processing of the captured images by the system may be desired by the user.

Background replacement, the replacement of the background captured within a video by another different image or video, can be particularly resource intensive and difficult to implement successfully in real-time, especially when computing resources are limited.

### SUMMARY

This document describes systems and techniques that may be used for GPU-assisted record-time processing of video images. In certain particular examples, the processing may involve background replacement in a video, such as to be used as part of a video teleconferencing system. For example, a user of such a system may not want other users to see what is behind them during a teleconference. Thus, as described below, they can capture a frame or frames of what is behind them (e.g., by turning on a web cam and moving out of the way) so that the capture frames may represent a “reference background.” If multiple frames are captured, a system may identify pixels that do not change between the frames to confirm that they are really part of a set background, and not some transient event, such as a person walking through the view of the camera.

During run-time then, the analyzed reference background can be used to identify what is the foreground of the video to be transmitted (e.g., the person who is on the videoconference) and what is the background—which is referenced here as the “replaced background.” In particular, where pixels or groups of pixels from the reference background match the image that is being captured at run-time, the system may assume that those pixels are part of the “replaced background” and need to be replaced with a “replacement background” (whereas non-matching pixels represent foreground objects that should be kept in the image). The replacement background may be a stock image or video to which the user has pointed (e.g., from a library stored locally on the user's computing device, or accessed through a network such as the internet). As one example, a user may want to replace the background that is actually behind them with a blank background or a pleasing background such as a Caribbean beach scene.

Certain aspects of the real-time foreground and/or the replacement background may be adjusted so that one better matches the other when they are displayed together. For example, colors in the foreground may be adjusted to better match the background. As one example, if the background has a large amount of red coloring (e.g., it shows a sunset or flowing lava), the person shown in the foreground may also take on a slightly reddish tint. Or if the system determines that the red is because of a sunset behind the person in the replacement background, the brightness of the foreground may be reduced to represent shadowing created by the sun behind them.

In general, one innovative aspect of the subject matter described in this specification can be embodied in methods that include the actions of identifying visual characteristics of a visual background, the visual background comprised of an image or series of images that make up a motion video; capturing one or more frames of a real-time video with a video camera and distinguishing one or more foreground areas in the frames of the real-time video from one or more background areas in the frames of the real-time video by using the visual background, wherein the visual background displays an area that overlaps with an area in the one or more captured frames; using the identified visual characteristics of the visual background to modify visual characteristics of particular pixels in the obtained one or more frames of the real-time video, the modifying occurring in real-time with capturing the one or more frames by the video camera; and providing, for display, video data that superimposes images from the one or more foreground areas over the visual background without superimposing the background areas, wherein the visual characteristics of the particular pixels have been modified using the identified visual characteristics of the visual background. Other embodiments of this aspect include corresponding systems, apparatus, and computer programs, configured to perform the actions of the methods, encoded on computer storage devices.

In some implementations, using the identified visual characteristics of the visual background to modify the visual characteristics of the particular pixels may include analyzing the visual background to determine a color correction value and applying the color correction value to modify at least one color value of the particular pixels.

In some implementations, the method may further include capturing a plurality of frames of background video with the video camera, wherein the visual background is the background video. Distinguishing the one or more foreground areas may include comparing the real-time video with the background video.

In some implementations, comparing the real-time video with the background video may include comparing an area of a frame of the real-time video with the corresponding area of the background video. In response to determining that compared areas are similar, a sub-area within the area of the frame of the real-time video may be compared with the corresponding area of the background video.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows an illustration of a background replacement method in accordance with an implementation of the disclosure.

FIG. 2 is a flowchart of an example process for background replacement.

FIG. 3 is a flowchart of an example process for identifying foreground and background within a recorded video frame.

FIG. 4 shows aspects of an example device for capturing and processing video, which may be used with the techniques described here.

FIG. 5 shows an example of a generic computer device and a generic mobile computer device, which may be used with the techniques described here.

### DETAILED DESCRIPTION

This document describes mechanisms by which a computing system may perform real-time background replacement on a video image using a GPU. For example, a computer user who is having a video chat may want to prevent others in the chat session from seeing items that are behind the first user (e.g., the first user may be an attorney or an engineer who has confidential information on whiteboards in his or her office) or from being distracted by such items. The first user might also simply want to replace their background with a background that is more pleasing or more fitting to a mood they want to communicate, such as by inserting a background of a tropical beach behind them. Such operations require a computer system to first identify what is the foreground in the first video to be maintained and what is the background to be removed. The computer system then superimposes the foreground (e.g., the user himself or herself) onto the background (e.g., the beach scene, which may be static, an animation that simulates waves moving on a beach, or an actual video of a beach). In such a situation, a user in an office may be lit by fluorescent lighting, while the replacement background may be lit by strong sunlight, so the computer system can also modify the foreground objects to match the lighting and/or coloring of their new background—all in real-time.

In some situations, the replacement background may be captured initially by a system for a user, such as by the user pointing a web cam at something they want to be the replacement background image (either a single frame or a series of frames).

Also, a “reference” background that is the background the user wants to replace, but captured without the user or other foreground objects in front of it, may be captured immediately before the replacement process begins. Thus, in addition to identifying a replacement background, the system may capture a series of frames for reference as the background to be replaced. These background reference frames are used to form a pixel unit key. For each spatial coordinate over the series of frames that are captured of the reference background, the computing system uses the values associated with each pixel unit in that coordinate to generate reference values for that location in the image. Thus, each spatial location in the pixel unit key includes reference values, each representing the mean values (color, intensity, and/or hue) for the pixels in that spatial location in the background reference frames and the standard deviation in each of those values.

In other instances, a user can select pre-recorded individual frames or series of frames in a video. For individual frames, the image file may be accessed by the system and pixel unit values may be computed as just discussed. For series of frames (e.g., for video), the pixel unit values may be taken for each frame, each n-th frame, or some other sub-set of frames, so that the pixel values change as the background changes. The pixel values may then be stored for use in later distinguishing the background from the foreground in the real-time replacement process

The pixel unit keys are then stored with the frame(s) for the background until a user wants to begin video recording with background replacement (e.g., as part of a video teleconference), so that a recorded background is replaced with the previously captured replacement background. For example, upon command from the user, the computing system can begin recording the actual video that will be subject to background replacement. For each frame of recorded video, the system compares the recorded frame against the pixel unit key to decide which parts of the video frame are background to be replaced, and which parts of the frame are foreground to keep. Parts of the real-time video image that are close enough to the reference background to be considered part of the recorded background are replaced in the modified frame by the same relative spatial portions of the replacement background (e.g., where the backgrounds may be scaled to match in pixel dimensions and cropped or compressed in one dimension to match in aspect ratio). Parts of the real-time video image that are different enough from the reference background to be recognized as recorded foreground are not replaced, although they may be hue-shifted to match hues of the replacement background.

As used herein, the term “pixel unit” may refer to one or more pixels that form the basic data unit processed by the computing system when recording. In some implementations, the camera may be able to record at one resolution (for example, at 2560 by 1600 pixels), but a four-pixel pixel unit (e.g., 2×2 pixels or 1×4 or 4×1 pixels) may be employed so that the processing is performed at a lower level of resolution wherein groups of four pixels form a pixel unit (resulting in a resolution for the image processing of 1280 by 800 pixel units).

Furthermore, because the process described herein involves replacement of a captured background with a background from a stored image or video file in certain examples, multiple resolution levels may be involved in the process. Just as pixel processing may not always be performed one-to-one, so pixel substitution may be performed one-to-many or many-to-one in order to match resolution between two images. Thus, for example when selecting pixels from a replacement background to be used in a communication, e.g., as a user in the foreground moves around, the process may grab blocks of pixels around the computed location of the foreground, rather than individual pixels.

Known image processing may be used to process higher- or lower-resolution versions of the images. Many of these conversion and translation processes may, in some implementations, already be a part of the graphics system that manages the GPU and display, which may use a cross-platform API such as OpenGL.

In some implementations, these processes may be performed on a mobile device such as a telephone or tablet computer. These methods are designed to allow background recognition and replacement to occur even with limited computing resources, such as the reduced memory and processing power available on a mobile computing device. Additionally, these methods are advantageous in that they can occur, in certain implementations, in “real-time” or “record-time” as the recording takes place and on a mobile computing device, rather than requiring further post-processing time after the recording is already made.

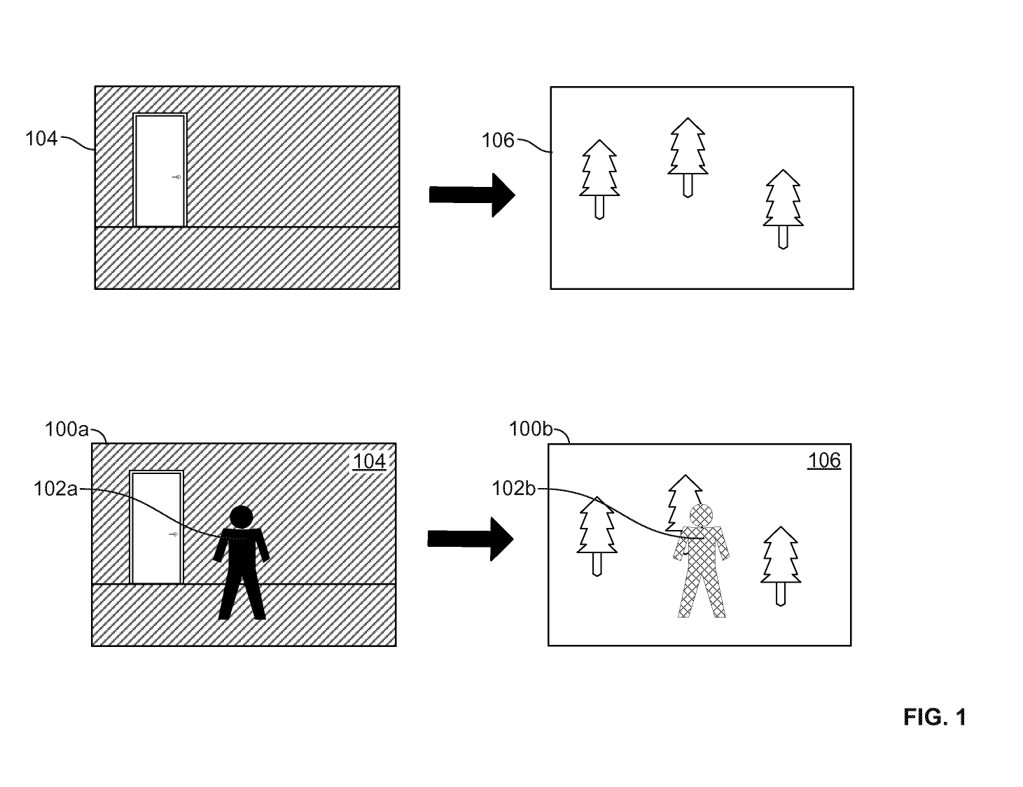

FIG. 1 illustrates an example of background replacement. Generally, a recorded, original background—a “replaced” background—that is part of an overall captured video scene (along with foreground elements) and represents an indoor scene, and is replaced by a replacement background that represents an outdoor scene, while the person in the foreground is not replaced. The color of the foreground image (which will be a number of frames as the person in the foreground moves) may be altered to better match the replacement background.

In FIG. 1, a first video image 100a shows a person in a room; the person represents the foreground 102a of the image while the room is seen in the background 104 of the image (which becomes the replaced background). In accordance with one implementation, a second video image 100b is shown and substitutes a replacement background 106 for the original, replaced background 104. The same person is shown in the foreground 102b, except that the foreground 102b is color-shifted from the recorded foreground 102a to compensate for the color difference between the replaced room background 104 and the replacement outdoor background 106. The first video image 100a is thus the image that is captured in real-time, while the second video image 100b is the image that is displayed, such as by being broadcast to other members of a video teleconference and displayed on their computers.

As illustrated, in some implementations, in preparation for substituting a replacement background for the original replaced background in the video, the application may first record frames of background 104 without a foreground image, thus allowing the background 104 to be used as a “key” in replacing portions of the image with the substitute background 106. These frames of background may be used to generate a background reference image for the reference background, which may be a single static frame or a series of frames in a video. For example, a user who is about to start a conference call may point a web camera out her window to capture one or more frames of images and may make a selection when she is done capturing such information. The file of the captured information may then be saved in a location that is accessible to the system, and processing as described above and below may be performed on the information to treat it properly as a replacement background that is applied in place of the portion of the real-time captured video that is not determined to be foreground objects.

Once the background reference image is generated or otherwise located (e.g., if the user points to a previously-generated image saved in the system), the system may switch to a real-time phase in which it captures frames of the user interacting with the system, and replaces a background from such frames (a replaced background) with the captured replacement background image. For example, the user may select a control in a videoconferencing software application in order to institute a videoconference with other computer users, which may cause a web cam to begin capturing the user's image as consecutive frames of video and replacing the background from those frames (which background is distinguished from foreground objects by using the reference background that the user previously captured) with the previously-captured replacement background, so as to display such an altered image both on the user's computing device, and to broadcast the same to other users logged onto the videoconference.

Such a real-time process may include movement in the foreground 102a, which will ideally be reproduced as the foreground 102b in video image 102b (with possible color correction as discussed in more detail below). For example, the user may move around in her chair during the videoconference, and her image may be made to appear as if it is moving in front of the replacement background that has been overlaid on her real, replaced background. Also, where the replacement background is a video clip, that clip can be repeated (looped) as a series of frames behind the user, and the looping can include one or more videos. For example, a user could select a sequence of four five-minute videos to serve as replacement backgrounds—e.g., where the respective videos show an outdoor scene in Winter, Spring, Summer, and Fall. The first video may run during a videoconference and then be replaced by the second video when the first is finished, for a total duration of 20 minutes for the four videos. Where the call is scheduled for 20 minutes, the other callers can be cued visually for the impending end of the call by the seasonal change.

Similarly, a series of photos may be taken of a cityscape from dawn to dusk, and may be assembled into a single file. A user may enter into the system an expected length of the call (e.g., 30 minutes) and those frames may be spaced across the time period as the call occurs—i.e., if the replacement background consists of 12 images taking each hour for 12 hours, the images may be switched every 2.5 minutes during the real-time videoconference. In that manner, as dusk appears in the background, the callers may be cued to understand that they are using up their scheduled time. And as described below, the lighting and other effects on the user's face and body in the foreground can be matched to the current lighting of the background (e.g., lighting one side of the body more in the morning, and the other in the evening).

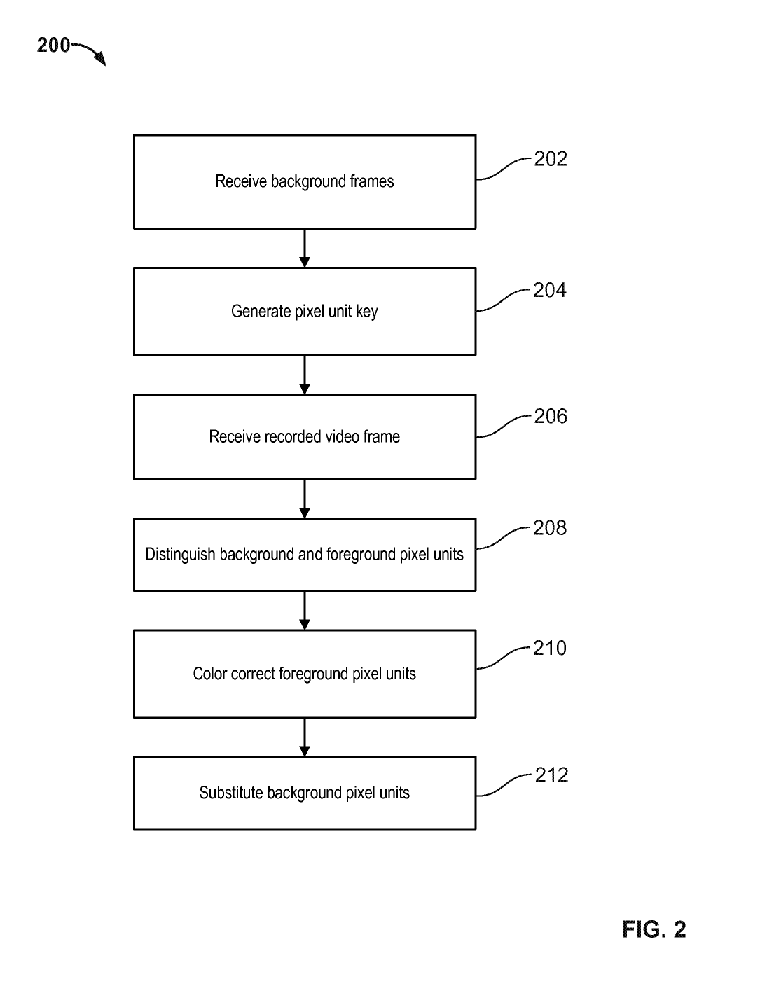

FIG. 2 is a flowchart of a process 200 for background replacement. In general, the process involves generating a reference background image, which is used to distinguish between the foreground and replaced background portions in each frame of a series of frames that are later captured with the same background (i.e., the replaced background matches the reference background), where that background is to be replaced with a replacement background that was previously captured (e.g., by the same user or someone else, and whether as a single frame or a series of frames such as in a video). The replacement background is then substituted for the portions of the recorded image identified as background (the replaced background), using the replacement background. The foreground portions may be color corrected to match the replacement background.

Referring now more specifically to particular actions in the process, the computing system records background frames for use in generating a background reference image (202). As part of configuring the computing system to record background frames, the user of the device (e.g., a desktop or tablet computer, or smartphone) may set the view by positioning a mobile device, adjusting a camera, or otherwise creating a relatively stable situation from which to generate the reference frames used to make the pixel unit key. For example, an application may instruct the user to position a web cam as it will be positioned for the later videoconference, and also tell the user to move out of the frame of the web cam until the user's computer beeps, indicating that the process has captured the reference background.

During the recording of the background reference frames, any objects or persons that the user intends to be part of the foreground, particularly subjects or objects that will move during the video capture (e.g., the user herself), should be removed from the field of view. The process may record for a period of time during which no substantial changes occur between frames of video, so that the process can determine that nothing from the foreground (at least nothing that moves) is in the web cam frame.

After the background reference frames have been recorded, the computing system may perform a quality approval step before proceeding further. The quality approval step may include analyzing the reference background frames to see if there is sufficient consistency (from one frame to the next) to form a useful background key. If the deviation between and/or among the reference background frames is too great—that is, if there is too much movement in the reference background or too many differences between frames, then the process may halt. Alternatively, the process may repeat and a fresh set of reference background frames may be captured. The quality approval step may eventually time out after multiple unsuccessful attempts at identifying a good reference background frame.

Once the reference background frame or frames have been recorded, the computing system uses the reference background frames to generate a pixel unit key (204). For example, the captured data for each of the reference background frames can be aggregated to form a mean and standard deviation for each pixel unit in the image. Depending on the properties of the video recording and the camera, values may be identified in multiple dimensions and may be processed for each pixel unit. For example, each pixel unit may include two color dimensions and one brightness dimension. The mean and standard deviation may be calculated independently in each dimension, yielding a final data structure with six values for each pixel unit. More or fewer dimensions may be used in different implementations.

Calculating a unique pixel unit key for the reference background frames can have various advantages. Because each camera will have idiosyncrasies with respect to its sensor array, noise levels and other aberrations can be compensated for by adjusting the detection sensitivity to the actual level of fluctuation observed in the reference background frames. Other characteristics of the recording environment, such as the color scheme and light levels, may also influence the values of the pixel unit key.

Once the computing system has generated the pixel unit key, the computing system carries out the remaining steps 206-212 for each captured frame of video that is to be altered by the background replacement process.

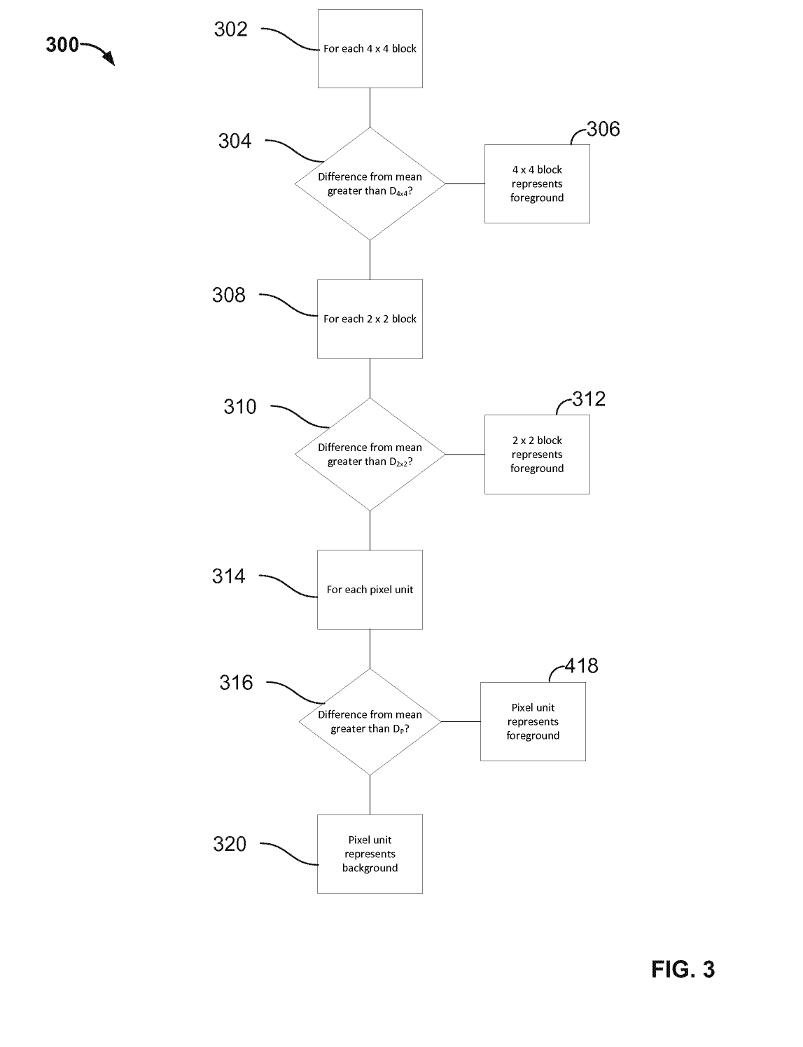

First, the computing system receives a real-time recorded video frame or frames, that include items the user intends to have included in the foreground and those the user intends to have included in the background and replaced as such. (206). In some implementations, the recording device that captured the reference background frames also captures, during the same recording session, the frames to be altered by the background replacement process. For example, as a videoconference begins, a user may move out-of-frame to capture images for a reference background, and then may move back into the frame with the web cam still recording, and the replacement process may then begin by using the previously captured images to identify a reference background. The pixel units of the received real-time captured frame are then analyzed to determine which are foreground and which are background (208). This process may involve multiple steps of comparing elements of the real-time captured image, from individual pixel units to larger groups of pixel units, to corresponding elements of the pixel unit key from the reference background. For each element to be evaluated, one or more weighted thresholds may be set that may depend on the size of the element as well as the standard deviations that correspond to that element in the pixel unit key. Pixel units in the real-time captured image that differ from the reference background key by an amount beyond the threshold may be identified as foreground; pixel units that are sufficiently close to the key may be identified as background. An example implementation 300 of a process for distinguishing background and foreground portions of the frame is further described in reference to FIG. 3 below.

For each pixel unit in the real-time captured images that the computing system identifies as foreground, a color correction may be applied (210). The color correction may be a set value that is derived from the deviation of the replacement background image from the grey world—that is, the process runs a grey world process to determine appropriate scaling factors, then apply those scaling factors in reverse in order to color-correct the foreground image to match the substitute background. Other color correction processes are possible.

For each pixel unit identified as background in the real-time captured video, the computing system replaces the recorded pixel unit with the corresponding pixel unit in the replacement background (212). In preparation for the substitution, the replacement background may be processed to a resolution that matches the resolution of the recorded frame, so that each pixel unit of the recorded frame has a corresponding pixel unit of the replacement background. Similarly, if the aspect ratios do not match, one of the images may be compressed or stretch along a dimension to make them match, or one of the images may be cropped on opposed sides. Other data formatting methods may be used in order to determine what element will replace each pixel unit of the real-time recorded image that is determined to be background.

Where the replacement background is itself a video that changes over time, it may also be necessary to perform some synchronization function between the frames of the video that represents the replacement background and the real-time recorded video. An average frame rate may be used and specific frames may be pre-matched; alternatively, a time index may be used and, for each received frame, the frame of the replacement background video that most closely matches the time index may be match to the corresponding real-time frame foreground.

This pixel unit substitution may, in practice, be carried out in a number of ways. For example, the replacement background image or video may be a display layer that includes alpha transparency values for each pixel unit. The replacement background layer may overlay the real-time recorded video layer. The alpha values may then be set according to the foreground/background determinations for each pixel unit, with a fully opaque transparency value corresponding to the location of background pixel units to be replaced, and a fully transparent value corresponding to the location of foreground pixel units to not be replaced. This layering process may allow the GPU to construct and display the video with background replacement using existing functions and imaging tools and a known data structure.

By processing each image as part of real-time video capture, the video may be displayed as it is captured and/or recorded (thus allowing the user to view the recording as it is generated), may be broadcast in real time to other users (such as via a videoconference), and may be stored for upload or later display.

FIG. 3 is a flowchart that shows a process 300 by which identification of foreground and background pixels units may be made. The process uses reduced-resolution blocks to more quickly distinguish foreground areas of the frame from background areas to be replaced, and to reduce total processing time. At each level, the computing system compares the mean values of pixel blocks against the mean values from the corresponding areas of the pixel key, scaled according the standard deviations in the pixel keys. Blocks that are different enough from the pixel key are identified as foreground. Blocks not identified as foreground are broken into smaller blocks and again compared against the corresponding areas of the pixel key. Once the computing system has broken the remaining blocks down into pixel units, the pixel units that are still similar enough to the pixel key are identified as background.

As shown in more detail in the example steps shown here, the process may begin by comparing 4×4 blocks of pixel units (302). Where the pixel unit is itself a 2×2 block of pixels, this 4×4 block represents 64 pixels of the original image, or 16 pixel units. Using the earlier example of a 2560 by 1600 original image reduced to a 1280 by 800 pixel unit array, this level of the process will further reduce the image to a 320 by 200 array of blocks, allowing the processing to be carried out on a relatively-few 64,000 elements—greatly reduced from the over 1 million elements in the full pixel unit array (much less the 4 megapixels in the original full-resolution image).

Many graphics systems will, as part of their normal graphics processing, already generate lower-resolution versions of an image. Thus, in some implementations, the 4×4 blocks of pixel units, along with the 2×2 blocks and the pixel units themselves, may already exist as part of the graphics processing system and do not have to be freshly generated.

To compare this array of elements to the pixel unit key, a low-resolution version of the key itself may also be generated. The computing system may generate the low-resolution version of the pixel unit key using the same known resolution processes that produce the lower-resolution versions of the recorded image.

In addition to generating a mean in each dimension for each block in the low-resolution key, a standard deviation in each dimension may be generated. This may be performed with a known equation for combining standard deviations; in some implementations, a simple mean or maximum of the standard deviations of the pixel units may be used as the standard deviation of the 4×4 block to simplify the procedure.

The difference between the recorded 4×4 block and the block from the background key is evaluated against a threshold (304). Because this may be the first of multiple steps comparing more refined elements against stricter thresholds, the threshold here may be particularly high—that is, only a relatively extreme deviation from the key may result in the entire block being identified as foreground.

In one implementation, in which the values are compared in three dimensions, the evaluation may represent a weighted single-value formula similar to the following:

W₁*|C₁−μ₁|/σ₁+W₂*|C₂−μ₂|/σ₂+W₃*|C₃−μ₃|/σ₃>D_{4×4}

where:
C₁, C₂, C₃: the mean values of the recorded blocks in each of the three dimensions;
μ₁, μ₂, μ₃: the mean values of the pixel key blocks in each of the three dimensions;
σ₁, σ₂, σ₃: the standard deviations of the pixel key blocks in each of the three dimensions; and
W₁, W₂, W₃: weighting factors for the three dimensions.

The weighting factors W may be particularly important where not all dimensions are equally valuable for determining background. For example, shadows are a common problem in background replacement. It is not desirable for a shadow that changes the brightness level of part of the background to be mistaken for part of the foreground. Therefore, in situations in which shadows may affect the brightness of the background but not significantly change the color, it may be advantageous to weight the brightness channel significantly less than the color channels. For example, the weights of each of the color channels W1 and W2 may be 1.35, while the weight of the brightness channel W3 may be 0.4. Under these weights, even a moderate deviation in hue is more likely to surpass the threshold than a significant deviation in brightness.

If the total equation is satisfied with the relatively large D_{4×4} value, then the pixel unit block is identified as foreground (306). Otherwise, each of the four 2×2 pixel unit blocks composing the 4×4 block is evaluated (308).

The mean values for each 2×2 pixel block may be uniquely generated or may have already been generated as part of other processing performed by components of the graphics system, as discussed above with respect to step 302. The following equation may then be evaluated at step 310:

W₁*|C₁−μ₁|/σ₁+W₂*|C₂−μ₂|/σ₂+W₃*|C₃−μ₃|/σ₃>D_{2×2}

Because the mean (μ) and standard deviation (σ) values reflect the pixel unit key block values for each 2×2 block, these variables reflect different values than they did above when evaluating the full 4×4 block. The further evaluation permits a more refined detection of differences more appropriate to a smaller area of the image. Therefore, in some implementations, D_{4×4}>D_{2×2}, representing that a relatively smaller deviation from the pixel unit key can cause a 2×2 block to be identified as foreground (312).

If the computing system does not identify a 2×2 as foreground because its deviation from the pixel unit key does not exceed the second threshold, then the computing system may further evaluate the individual pixel units in that block (314). Here, the pixel unit key and recorded image values are used at their pixel unit resolutions, which may be reduced from their original resolutions. The difference between each recorded pixel unit and the corresponding background key pixel unit may be evaluated against a threshold (316) such as by the following equation:

W₁*|C₁−μ₁|/σ₁+W₂*|C₂−μ₂|/σ₂+W₃*|C₃−μ₃|/σ₃>D_{P}

Again, the mean and standard deviation values in this equation reflect the values for each pixel unit in the pixel unit key, representing the values generated from the background reference frames. The value of the third threshold D_{P} may represent a stricter threshold than the earlier thresholds used for larger pixel blocks; that is, D_{4×4}>D_{2×2}>D_{P}. Each pixel with a difference that exceeds the threshold may be identified as foreground (316), while each pixel that falls within even this strictest threshold may be identified as background (318).

Although the equations expressed above use a single aggregated signal to determine whether an element exceeds a threshold sufficiently to be considered foreground, alternative implementations may evaluate each dimension separately, and may consider the element foreground if any evaluated dimension exceeds a set threshold.

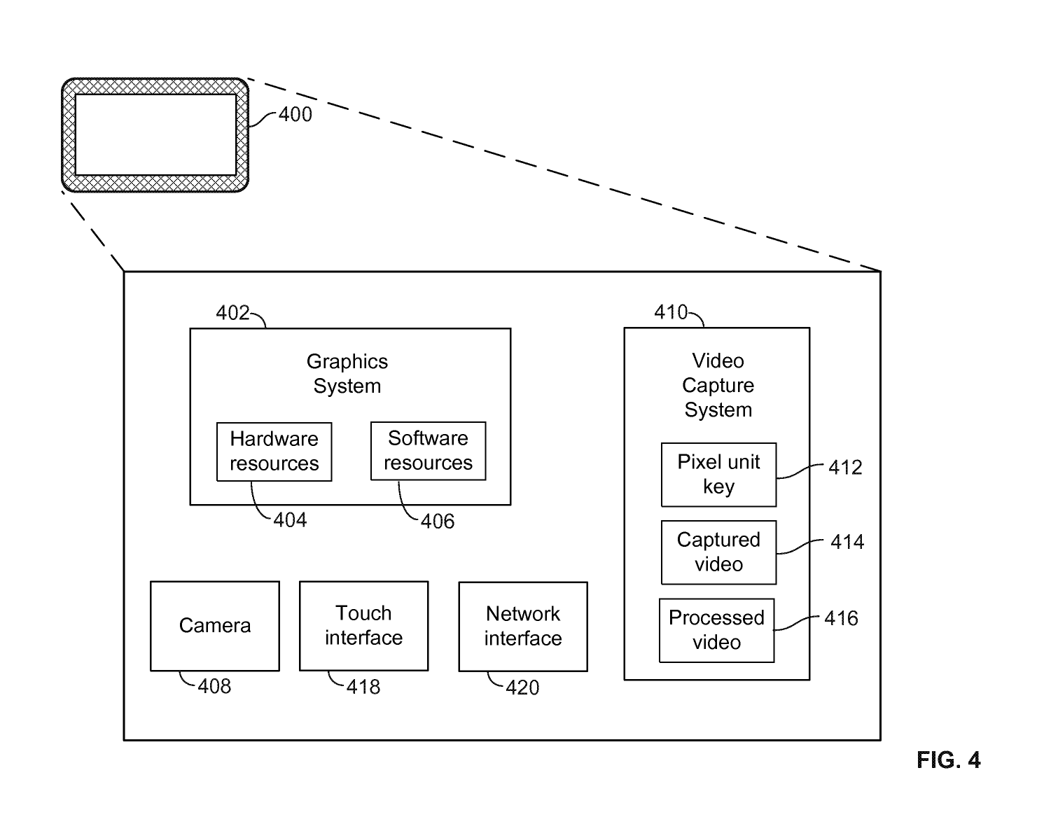

FIG. 4 shows a tablet computing device as one example of a computing system in which record-time background replacement can occur in a resource-constrained computing environment using a GPU. The device 400 may be any computing device that includes at least one dedicated hardware resource available for processing graphics (such as a GPU) in addition to the generalized resources used for other computer processes (such as a CPU). Although the device 400 is shown and described as a tablet computer having a touch interface, any appropriate computing system having hardware accelerated rendering may benefit from implementations disclosed herein.

A graphics system 402, responsible for managing the resources and environment underlying all display on the device 400, includes both hardware resources 404 and software resources 406 for rendering displays and processing video, including recorded video. The graphics system may be a known API such as OpenGL, or a custom or proprietary system capable of managing the resources of the device 400. The hardware resources 404 may include a graphics processing unit (GPU) or other resources that can be dedicated to improving graphics rendering by their management and allocation. The software resources may include management processes for allocating and using generalized resources (such as the CPU, system RAM, etc) for drawing, rendering, processing, and displaying graphics on the system.

The system further includes video capture equipment such as a camera 408. A video capture system 410 may include resources to control the camera 408 as well as interfacing with the graphics system 402 in order to generate and reference pixel unit keys 412, capture and record video 414 with hardware including the camera 408, and process that video as needed in order to generate processed video 416. In some implementations, the recorded video 414 may not be stored in an unprocessed form, as video processing occurs at record-time and only the processed video 416 is stored or processed.

Further components, such as a touch interface 418, may interact with the graphics system 402 as well as the video capture system 410. A network interface 420 may allow communication over the Internet or other network, which may include live broadcasting of the processed video with background replacement. Other components may provide additional capabilities.

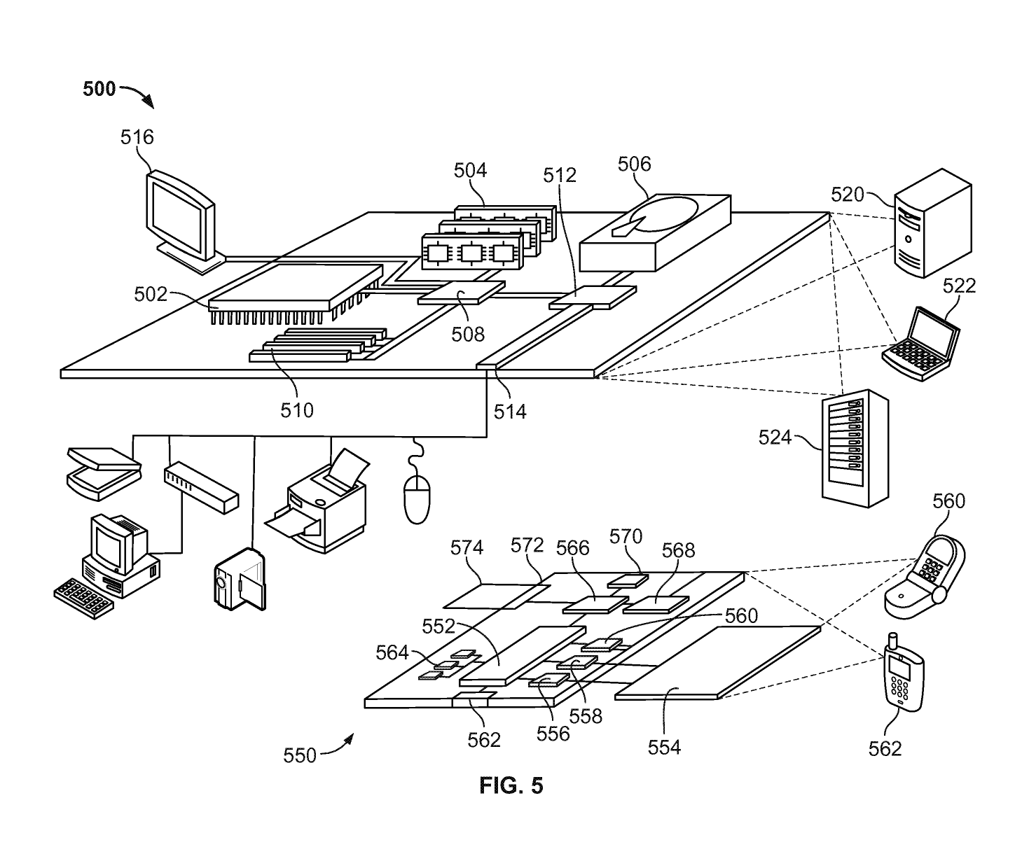

FIG. 5 shows an example of a generic computer device 500 and a generic mobile computer device 550, which may be used with the techniques described here.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers and other similar computing devices. The components shown here, their connections and relationships, and their functions, are meant to be exemplary only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, a digital camcorder, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented image processing method, comprising:
identifying visual characteristics of a visual background, the visual background comprised of an image or series of images that make up a motion video;
capturing one or more frames of a real-time video with a video camera and distinguishing one or more foreground areas in the frames of the real-time video from one or more background areas in the frames of the real-time video by using the visual background, wherein the visual background displays an area that overlaps with an area in the one or more captured frames;
using the identified visual characteristics of the visual background to modify visual characteristics of particular pixels in the obtained one or more frames of the real-time video, the modifying occurring in real-time with capturing the one or more frames by the video camera; and
providing, for display, video data that superimposes images from the one or more foreground areas over the visual background without superimposing the background areas, wherein the visual characteristics of the particular pixels have been modified using the identified visual characteristics of the visual background.

2. The method of claim 1, wherein using the identified visual characteristics of the visual background to modify the visual characteristics of the particular pixels comprises:
analyzing the visual background to determine a color correction value; and
applying the color correction value to modify at least one color value of the particular pixels.

3. The method of claim 1, further comprising:
capturing a plurality of frames of background video with the video camera, wherein the visual background is the background video;
wherein distinguishing the one or more foreground areas comprises comparing the real-time video with the background video.

4. The method of claim 3, wherein comparing the real-time video with the background video comprises:
comparing an area of a frame of the real-time video with the corresponding area of the background video;
in response to determining that compared areas are similar, comparing a sub-area within the area of the frame of the real-time video with the corresponding area of the background video.

5. A system comprising:
a video camera for capturing one or more frames of a real-time video; and
one or more computers comprising a first processor and one or more graphical processors, the one or more computers performing operations comprising:
identifying visual characteristics of a visual background, the visual background comprised of an image or series of images that make up a motion video;
distinguishing one or more foreground areas in the frames of the real-time video from one or more background areas in the frames of the real-time video by using the visual background, wherein the visual background displays an area that overlaps with an area in the one or more captured frames;
using the identified visual characteristics of the visual background to modify, by the one or more graphical processors, visual characteristics of particular pixels in the obtained one or more frames of the real-time video, the modifying occurring as the one or more frames are captured by the video camera; and
providing, for display, video data that superimposes images from the one or more foreground areas over the visual background without superimposing the background areas, wherein the visual characteristics of the particular pixels have been modified using the identified visual characteristics of the visual background.

6. The system of claim 5, wherein using the identified visual characteristics of the visual background to modify the visual characteristics of the particular pixels comprises:
analyzing the visual background to determine a color correction value; and
applying the color correction value to modify at least one color value of the particular pixels.

7. The system of claim 5, the operations further comprising:
capturing a plurality of frames of background video with the video camera, wherein the visual background is the background video;
wherein distinguishing the one or more foreground areas comprises comparing the real-time video with the background video.

8. The system of claim 7, wherein comparing the real-time video with the background video comprises:
comparing an area of a frame of the real-time video with the corresponding area of the background video;
in response to determining that compared areas are similar, comparing a sub-area within the area of the frame of the real-time video with the corresponding area of the background video.

9. A non-transitory computer-readable medium storing software comprising instructions executable by one or more computers which, upon such execution, cause the one or more computers to perform operations comprising:
identifying visual characteristics of a visual background, the visual background comprised of an image or series of images that make up a motion video;
capturing one or more frames of a real-time video with a video camera and distinguishing one or more foreground areas in the frames of the real-time video from one or more background areas in the frames of the real-time video by using the visual background, wherein the visual background displays an area that overlaps with an area in the one or more captured frames;
using the identified visual characteristics of the visual background to modify visual characteristics of particular pixels in the obtained one or more frames of the real-time video, the modifying occurring in real-time with capturing the one or more frames by the video camera; and
providing, for display, video data that superimposes images from the one or more foreground areas over the visual background without superimposing the background areas, wherein the visual characteristics of the particular pixels have been modified using the identified visual characteristics of the visual background.

10. The medium of claim 9, wherein using the identified visual characteristics of the visual background to modify the visual characteristics of the particular pixels comprises:
analyzing the visual background to determine a color correction value; and
applying the color correction value to modify at least one color value of the particular pixels.

11. The method of claim 9, further comprising:
capturing a plurality of frames of background video with the video camera, wherein the visual background is the background video;
wherein distinguishing the one or more foreground areas comprises comparing the real-time video with the background video.

12. The method of claim 11, wherein comparing the real-time video with the background video comprises:
comparing an area of a frame of the real-time video with the corresponding area of the background video;
in response to determining that compared areas are similar, comparing a sub-area within the area of the frame of the real-time video with the corresponding area of the background video.
